(19) United States
(12) Patent Application Publication
(10) Pub. No.: US 2024/0321539 A1
(43) Pub. Date: Sep. 26, 2024

(54) HOUSING FOR A MOTOR-VEHICLE RELAY AND SYSTEMS BASED THEREON

(71) Applicant: Thomas Kliem, Rottweil (DE)

(72) Inventor: Thomas Kliem, Rottweil (DE)

(21) Appl. No.: 18/579,139

(22) PCT Filed: Jul. 12, 2022
(86) PCT No.: PCT/EP2022/069451

§ 371 Date: Jan. 12, 2024

(30) Foreign Application Priority Data
Jul. 16, 2021 (DE) 20 2021 103 826.8

(51) Int. Cl. H01H 50/02; H01H 50/14

(52) U.S. Cl. CPC H01H 50/023; H01H 50/14; H01H 2231/026

(57) ABSTRACT

The invention relates to a housing for at least one at least 6-pole motor vehicle relay with at least six electrical connections in the form of flat terminals, having a cover that provides a volume space, open on one side, for receiving the motor vehicle relay, and at least one base that closes the volume space in a fluid-tight manner in the closed state, wherein the base, in a manner corresponding to the number of electrical connections of the motor vehicle relay, has at least six electrical contacts for the electrical connection of the motor vehicle relay, wherein each electrical contact is arranged in a separate contact chamber that is open towards the volume space, wherein each contact chamber is adjoined by a respective sealing space that is accessible from outside the housing, wherein a sealing element having a central channel for guiding electric wires is arranged in each sealing space.

### CROSS-REFERENCE TO RELATED APPLICATION

This application is a national stage application, filed under 35 U.S.C. § 371, of International Patent Application PCT/EP2022/069451, filed on Jul. 12, 2022, which claims the benefit of German Patent Application DE 20 2021 103 826.8, filed on Jul. 16, 2021.

### TECHNICAL FIELD

The disclosure relates to a housing for at least one at least 6-pole motor vehicle relay having at least six electrical connections in the form of flat terminals. The disclosure also relates to a modular system with at least two such housings and to a system with a housing and vehicle relay.

### BACKGROUND

Motor vehicle relays are well known from the prior art. They are robustly built relays that can withstand the increased requirements in motor vehicles in terms of impact resistance and temperature resistance. Thereby, from a technical point of view, electronic relays are to be distinguished from electromotive relays. They work with an on-board voltage of 12 V or 24 V and can switch comparatively high currents. As a rule, they have connections with standardized flat terminals with a width of 2.8×0.8 mm, 6.3×0.8 mm and/or 9.5×1.2 mm (DIN 46 244 A). The exact geometry and arrangement of the relay connections is also standardized (DIN ISO 7588, DIN ISO 8092) and thus basically specifies the geometry of the base of the housing via which the relay is connected in terms of line technology to the electrical system of the motor vehicle.

Depending on the desired function, relays with different poles, i.e. with different numbers of connections, are used. For example, 4-pole, 5-pole, 6-pole or 9-pole relays. In particular, 6-poles or higher, in particular 9-pole, relays are used in the vehicle sector as part of complex electronic control processes.

Depending on the site of installation in the vehicle, it may be necessary to protect the relay from external influences that could otherwise damage or destroy it. Depending on the number of relay connections, housings with standardized plastic bases are used to protect against mechanical influences. It is also necessary to protect relays from moisture in certain regions of the vehicle. Electronic relays are particularly susceptible in this respect. In principle, electromotive relays are more robust in this respect. However, moisture protection can also be useful for electromotive relays.

Thereby, in the motor vehicle sector, it is essential to work with standardized components that ensure the compatibility of all components with one another for all possible vehicle types from a wide range of manufacturers. However, in particular with reference to the base of the housing, there are only standardized parts for normal, non-watertight bases. A standard design for watertight bases is not available. In the prior art, attempts were therefore made to subsequently seal the standardized housings and bases, which are not watertight in and of themselves.

However, there are limitations with regard to the available space and the necessary wall thickness of the contact chamber/sealing spaces. For example, the molding devices require a certain minimum wall thickness, so that the walls are not damaged during demolding. Taking these requirements into account when using such standard parts, there is simply not enough space to ensure the necessary wall thickness, in particular with regard to the base of the housing if there are more than five relay connections.

For this reason, there are currently no fluid-tight, in particular watertight, housings for 6-pole or higher, in particular 9-pole, relays, since the known technical measures are no longer suitable for this.

In all other respects, it may be possible that watertight relay housings with which the housing and relay are individually matched to one another and manufactured exist. However, such housings have the disadvantage that they are not compatible with standardized motor vehicle relays. In particular, standardized components with high international availability, such as single-conductor seals, bases or relay connections, cannot be used otherwise. Such a product is therefore of no interest to the end customer.

### SUMMARY

Thus, the disclosure is based on the object of providing a fluid-tight housing that is suitable for receiving a higher-pole motor vehicle relay and enables the use of standardized relays and seals.

To achieve the object, a housing for at least one at least 6-pole motor vehicle relay with at least six electrical connections in the form of flat terminals has a cover that provides a volume space, open on one side, for receiving the motor vehicle relay, and at least one base that closes the volume space in a fluid-tight manner in the closed state, wherein the base, in a manner corresponding to the number of electrical connections of the motor vehicle relay, has at least six electrical contacts for the electrical connection of the motor vehicle relay, wherein each electrical contact is arranged in a separate contact chamber that is open towards the volume space, wherein each contact chamber is adjoined by a respective sealing space that is accessible from outside the housing, wherein a sealing element having a central channel for guiding electric wires is arranged in each sealing space.

The term “motor vehicle relay” here refers to electronic and/or electromechanical relays that are used in electrical systems of motor vehicles. Such relays are preferably used in passenger cars, but also in trucks.

The special combination of contact chamber, sealing space and sealing element arranged in the sealing space achieves a fluid-tight seal of the contact chamber, the contacts located therein and the individual conductors connected to the contacts in terms of line technology and guided to the outside through the sealing space. This also achieves fluid-tight sealing of the housing interior, i.e. the volume space delimited by the cover and base. The invention makes it possible for the first time to provide a fluid-tight housing for relays with nine or more connections. The arrangement of such relays in positions in the vehicle that inevitably come into contact with fluids, in particular liquids such as water, is no longer a problem by means of the invention, which means that the functions of the vehicle electronics can be extended in an advantageous manner. Therefore, a fluid-tight, in particular watertight, housing for 6-pole or higher, in particular 9-pole, relays is provided for the first time.

With conventional housings for relays standardized according to one of the standards DIN 46 244, DIN ISO 7588 and/or DIN ISO 8092, the contact chamber—and thus the contacts of the base—are accessible via a hollow cylindrical channel with a circular cross-sectional shape. The individual conductors via which the relay is connected to the respective on-board electronics run in such channels. The invention makes use of this standard design of conventional bases by using such channels, which are provided in any event, as sealing spaces. in accordance with the invention, a sealing element is arranged in each sealing space. The individual conductors are guided through the channel formed in the sealing element, in particular the central channel, and preferably reach completely through the seal.

The measures in accordance with the invention are sufficient to achieve fluid tightness in the region of the contact chambers. Depending on the site of application of the housing, this measure may already be sufficient to enable installation in regions with a certain level of exposure to moisture. Further features are preferred for complete fluid tightness, in particular water tightness.

Thereby, it is preferred that at least one of the sealing spaces has an oval, in particular elliptical, cross-sectional shape, in particular an outer and/or inner cross-sectional shape. By deliberately moving away from the familiar circular cross-section, sufficient wall thickness can be provided in an advantageous manner, despite the prevailing lack of space in bases with at least six contact chambers and sealing spaces, so that the walls of the sealing spaces are not damaged during demolding. Nevertheless, such measure makes it possible to dispense with the use of specially manufactured sealing elements. Instead, commercially available single-conductor seals known to the skilled person, which also have a full sealing effect in a sealing space modified within the tolerance range of the seal in accordance with the invention, can be used. Such single-conductor seals are preferably formed from rubber or synthetic plastics. They have a substantially hollow cylindrical cross-section. The inner and outer radius can vary along the length extension. Thus, the preferred design enables a particularly simple, user-friendly and inexpensive, but at the same time effective sealing of housings for relays with at least six, preferably nine or more connections.

In housings known from the prior art, a channel and an associated contact chamber are in each case arranged along a common central longitudinal axis. In accordance with a preferred embodiment of the invention, the contact chamber is arranged in a manner offset in the radial direction relative to the central longitudinal axis of the channel, which is designed as a sealing space in accordance with the invention. On the one hand, such measure is used to further facilitate demolding when producing the base. On the other hand, such offset improves the sealing effect of the sealing element in the sealing space. Specifically, the offset preferably also reduces the surface of the connection opening between the contact chamber and the sealing space. Thereby, an offset of between 0.05 mm and 1 mm, preferably between 0.2 mm and 0.7 mm, particularly preferably between 0.3 mm and 0.5 mm, has proven to be particularly advantageous.

Preferably, the respective contact arranged in the contact chamber is also arranged in a manner offset in relation to the same axis. Preferably, the contact is also offset by the same amount between 0.05 mm and 1 mm, preferably between 0.2 mm and 0.7 mm, particularly preferably between 0.3 mm and 0.5 mm. Thereby, the offset is selected so that the respective flat terminal of the relay is no longer received in a manner exactly centered in the contact chamber as intended. However, the offset of the contact chamber and/or the contact in accordance with the invention is within the tolerance range of the flat terminal, such that the intended function is not impaired. Preferably, the offset in particular is matched to this.

Preferably, the cover and/or the base can be formed from a fluid-tight material, in particular a plastic. Preferred plastics are polyethylene, polypropylene or comparable polyolefins or acrylonitrile-butadiene-styrene or polyurethane.

It is also preferable to provide the circumferential connection surface between the cover and base with a separate seal. This seal is also preferably formed from rubber or a synthetic plastic. The seal is preferably designed to be ring-shaped. In principle, the cross-section of the seal can be designed to be round or angular. It is preferably designed to be rectangular. It is preferable that the circumferential seal is arranged between the cover and base in the closed state of the housing and is subjected to contact pressure in both the axial and radial directions. This increases the sealing effect many times over compared to seals that are only acted upon in a radial direction. In detail, this is achieved by the fact that the seal is arranged both in the vertical direction of the housing and orthogonally to the vertical direction of the housing in each case, preferably completely, between the base and the cover. In this respect, a sealing effect is achieved in a radial and axial direction. The relevant contact pressure can be further increased by equipping the base and cover with suitable connecting elements. Preferably, there is a positive-locking and/or force-fitting connection between the two components. The connecting elements are preferably designed as latching means for forming a preferably detachable latching connection. The cover and base preferably have corresponding latching means. It is preferably provided that the base has two latching hooks arranged opposite one another in the radial direction, which engage in corresponding latching projections formed on the cover, preferably from the outside, and transmit a force directed both in the radial and axial direction to the cover and thus to the circumferential seal. Thereby, the seal is preferably arranged in a radial groove delimited by the cover and base. Thereby, the seal is dimensioned larger than the space volume of the groove. When a contact pressure is applied, the seal is pressed and compressed in a radial and axial direction against the walls of the cover and groove that delimit the groove. This achieves a particularly advantageous sealing effect.

Preferably, the circumferential seal for radial contact pressure has a sealing lip structure on one side, which creates a gradual contact pressure.

In accordance with a preferred feature of the invention, it is provided that the contact chamber has an angular, in particular rectangular, cross-sectional shape, in particular an internal cross-sectional shape. Thus, the cross-section corresponds to the external cross-section of a flat terminal of the relay. In this manner, the shape of the contact chamber advantageously is used as a centering aid for the respective flat terminal.

In accordance with a preferred feature of the invention, a fastening means arranged on the base is provided for directly fastening the base to an external housing carrier, in particular a vehicle. The fastening means are preferably designed as a lug. Such design has the advantage that the base can be fastened directly to the vehicle, such that the cover can be removed in simple manner, without having to dismantle the entire housing. The internal electronics, in particular the relay, can thus be replaced in a simple manner.

In accordance with a preferred feature of the invention, a fastening means arranged on the cover is provided for directly fastening the cover to an external housing carrier, in particular a vehicle. The fastening means are preferably designed as a latching tab. The latching tab is preferably arranged in a recess or pocket formed on the cover. The latching tab preferably interacts with a lug, in particular a metal lug, provided by the housing carrier. Such design has the advantage that the cover can be fastened directly to the vehicle, such that the base with the relay attached can be removed in simple manner, without having to dismantle the entire housing. The internal electronics, in particular the relay, can thus be replaced in a simple manner.

It is also preferred that a housing can comprise a plurality of bases for receiving a plurality of relays. The design as a double-base housing is particularly preferred. Thereby, either two individual bases are connected to one another and closed by a correspondingly dimensioned common cover. Alternatively, the base can be designed in one piece and provide the contact chamber, contacts and sealing spaces for the corresponding double number of relay connections. In this case as well, it is preferable that a correspondingly dimensioned common cover seals the housing.

The invention also relates to a modular system having at least two housings in accordance with the invention, wherein two or more housings can be coupled to one another via corresponding connecting means along edges running in parallel. Thereby, a watertight arrangement of a plurality of relays at system-critical points in the vehicle can be realized in a highly flexible manner.

The connecting means are preferably formed by latching means that correspond to one another.

Preferably, individual housings can be coupled to form a modular system in two spatial directions, so that different planar designs of the system can be formed. Thus, chains, blocks or even entire surfaces can be formed from housings.

The invention also relates to a system having a housing in accordance with the invention and an at least 6-pole or higher-pole motor vehicle relay, wherein the motor vehicle relay is arranged in the volume space of the cover that is sealed in a fluid-tight manner, wherein the motor vehicle relay has flat terminals that are inserted into the respective corresponding contact chamber and are in contact with the respective corresponding electrical contact of the base. The invention provides a fluid-tight system for higher-pole relays for the first time. Preferably, the flat terminals are standardized flat terminals with a width of 2.8×0.8 mm, 6.3×0.8 mm and/or 9.5×1.2 mm (DIN 46 244 A).

In particular, the relay is an electronic relay, preferably a field-effect transistor, in particular a MOS-FET relay.

The invention is described in detail below with reference to exemplary embodiments. The exemplary embodiments are for explanatory purposes only and are not to be understood as limiting the overall disclosure.

### BRIEF DESCRIPTION OF THE DRAWINGS

FIG. 1 shows a housing for a motor vehicle relay in different views;

FIG. 2 shows a housing for a motor vehicle relay in a view from below;

FIG. 3 shows a housing for a motor vehicle relay in a sectional view;

FIG. 4 shows a housing for a motor vehicle relay in a further sectional view;

FIG. 5 shows a housing for a motor vehicle relay in a further sectional view;

FIG. 6 shows a housing for a motor vehicle relay in a further sectional view;

FIG. 7 shows a system of a housing and a relay in different views;

FIG. 8 shows a modular system with two housings in different views.

### DETAILED DESCRIPTION

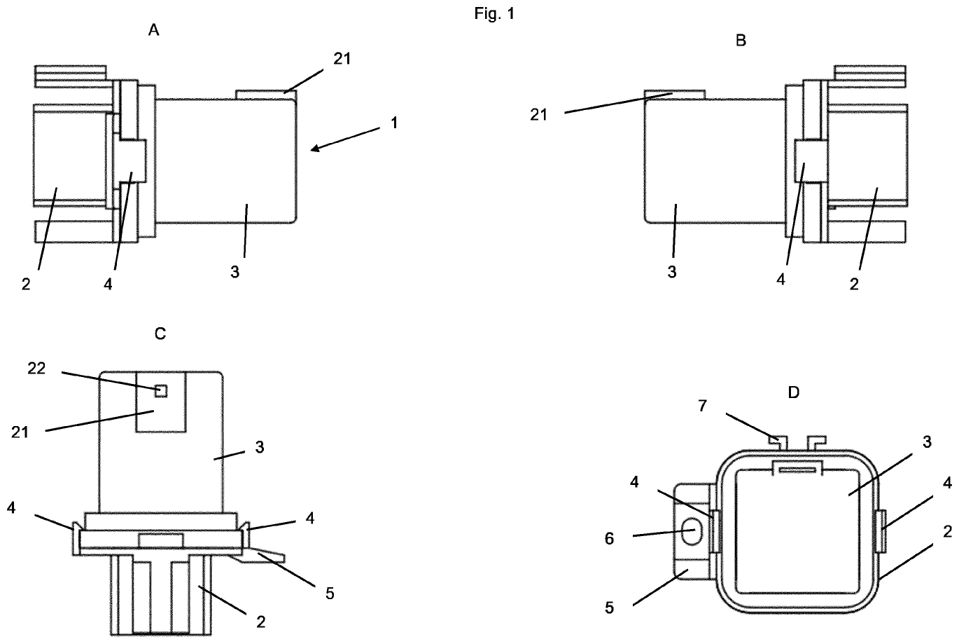

FIG. 1 shows a housing 1 in accordance with the invention, having a base 2 and a cover 3. The housing 1 is shown from three different sides (views A, B and C), and from above with a view of the upper side of the cover 3 (view D).

The base 2 can be seen, which is connected to the cover 3 as intended and seals the cover 3 in a fluid-tight manner. The base 2 is connected in a positive-locking and/or force-fitting manner to the cover 3 via the latching hooks 4.

A fastening lug 5 is also arranged on the base 2, which fastening lug is used to fasten the housing 1 to an external carrier structure, such as a correspondingly equipped vehicle. The fastening lug 5 has a central recess 6 for this purpose. Thereby, the recess can take the form of a bore.

A pocket 21 in which a latching tab 22 is received is also formed on the cover 3. The latching tab 22 is used to fasten the housing 1 to an external carrier structure, such as a correspondingly equipped vehicle. As intended, the latching tab 22 interacts with a metal lug provided by the carrier structure.

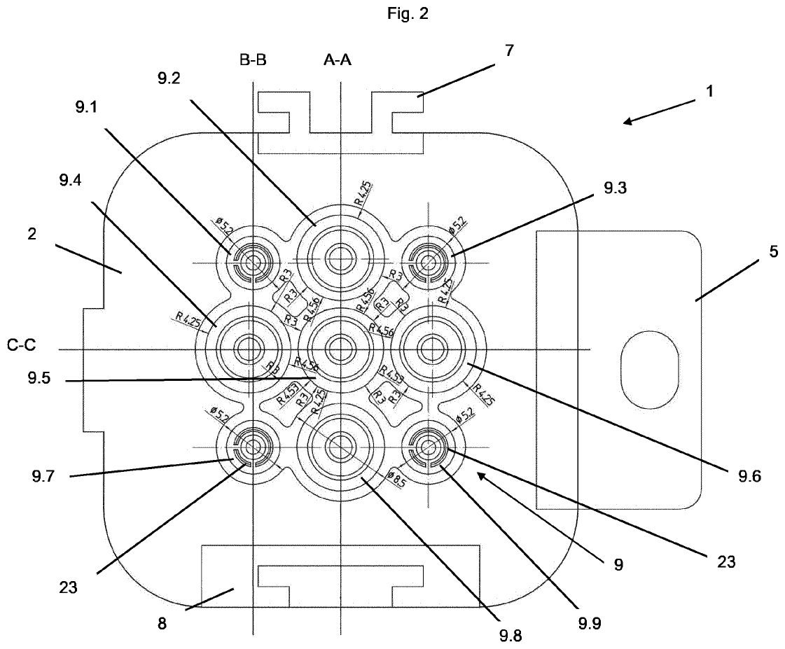

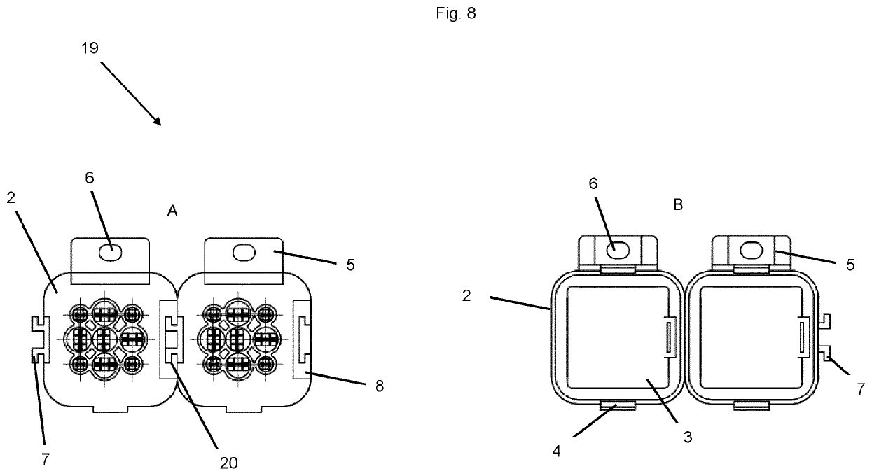

FIG. 2 shows the housing in accordance with the invention from below with a view to the base 2. The connecting means 7, 8 that correspond to one another can be seen. Which is used to connect to a further housing 1 with identical connecting means 7, 8 to form a modular system shown in more detail in FIG. 8. In the present case, the connecting means 7, 8 are designed as corresponding shaped elements, which is used to establish a positive-locking connection. Thereby, the connecting means 7 have two connecting bars extending in opposite directions, which engage in a recess formed in the connecting means 8.

This view also shows nine sealing spaces 9, which are arranged in the form of a grid. Thereby, the outer walls 12 of each sealing space 9 contact the outer walls 12 of the directly adjacent sealing spaces 9. This advantageously increases the mechanical stability of the sealing spaces and thus prevents undesired compression of the sealing elements 23 to be arranged in the sealing space 9 in the radial direction, even under increased pressure. This increases the overall fluid tightness of the housing 1, even under comparatively high pressure. In the present case, the sealing elements 23 are arranged in the sealing spaces 9.1, 9.3, 9.7 and 9.9. In the present case, the sealing elements 23 are designed as single-conductor seals.

The contact chambers 10, which are not visible in FIG. 1, extend directly to the individual sealing spaces 9 in the direction of the image plane.

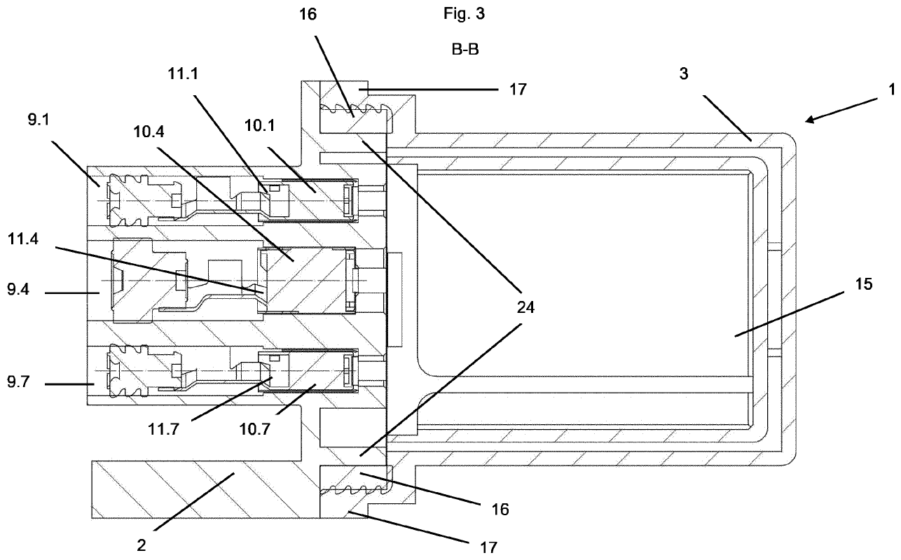

FIG. 3 shows a sectional view along the axis B-B marked in FIG. 2. The sealing spaces 9.1, 9.4 and 9.7 can be seen. The sealing elements 23 are arranged in the sealing spaces 9.1 and 9.7.

The sealing spaces 9.1, 9.4 and 9.7 are adjoined by the contact chambers 10. In the present case, the contact chamber 10.1 adjoins the sealing space 9.1, the contact chamber 10.4 adjoins the sealing space 9.4 and the contact chamber 10.7 adjoins the sealing space 9.7.

The sealing element 23 arranged in the respective sealing space 9 seals the contact chamber 10 in each case adjoining the respective sealing space 9 in a fluid-tight manner against moisture acting on the sealing space side.

When a relay 14 is arranged as intended in the housing 1, the contact chambers 10 are used for receiving relay connections, in particular a flat terminal 18 in each case.

The contacts 11, specifically 11.1, 11.4 and 11.7, are arranged in the contact chamber 10 to establish an electrically conductive connection with the respective relay connection 18.

In the present case, the volume space 15 provided by the cover 3 is sealed in a fluid-tight manner by the base 2. For this purpose, a circumferential seal 16 is arranged in the radial and axial direction between the cover 3 and the base 2 with reference to the image plane of view B of FIG. 2 and, in the present closed state of the housing 1, is subjected to a contact pressure in precisely such directions. This ensures that the same fluid tightness, in particular water tightness, is achieved regardless of the spatial orientation of the housing 1. For this purpose, the base 2 provides a circumferential contact surface 24, against which the seal 16 is pressed in a radial direction when it is fastened to the cover 3 as intended.

To establish the contact pressure, the latching hooks 4 shown in FIG. 1 are formed on opposite sides of the base 2, which engage around a circumferential edge 17 of the cover 3 from the outside and engage in a positive-locking manner behind it. This transmits a force to the seal in both the axial and radial directions.

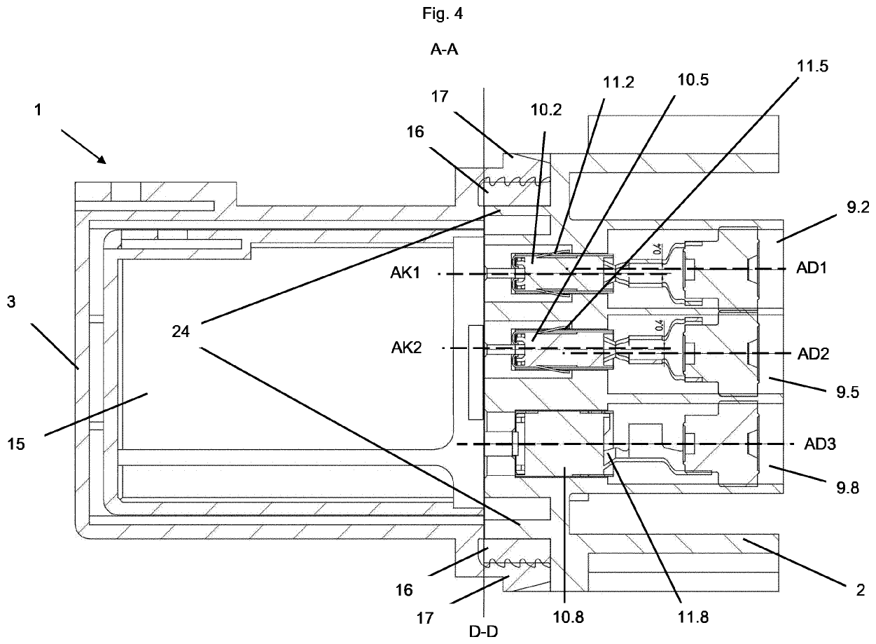

FIG. 4 shows a sectional view along the axis A-A marked in FIG. 2. The sealing spaces 9.2, 9.5 and 9.8 can be seen.

The sealing spaces 9.2, 9.5 and 9.8 are adjoined by the contact chambers 10. In the present case, the contact chamber 10.2 adjoins the sealing space 9.2, the contact chamber 10.5 adjoins the sealing space 9.5 and the contact chamber 10.8 adjoins the sealing space 9.8.

The contacts 11, specifically 11.2, 11.5 and 11.8, are arranged in the contact chamber 10.2, 10.5 and 10.8 to establish an electrically conductive connection with the respective relay connection 18.

In the present case, the contact chamber 10.2 and the contact 11.2 are arranged in a manner offset in relation to the central longitudinal axis AD1 of the sealing space 9.2. In particular, the central longitudinal axis AK1 of the contact chamber 10.2 is arranged in a manner offset in the radial direction in relation to the longitudinal axis AD1 of the sealing space 9.2. In the present case, the offset amounts to 0.4 mm. Furthermore, in the present case the contact chamber 10.5 and the contact 11.5 are arranged in a manner offset in relation to the central longitudinal axis AD2 of the sealing space 9.5. In particular, the central longitudinal axis AK2 of the contact chamber 10.5 is arranged in a manner offset in the radial direction in relation to the longitudinal axis AD2 of the sealing space 9.5. In the present case, the offset amounts to 0.4 mm.

In contrast, the sealing space 9.8, the contact chamber 10.8 and the contact 11.8 are arranged coaxially on the common central longitudinal axis AD3.

The sealing spaces 9, which are adjoined by the contact chambers 10 offset with reference to the respective longitudinal axis, have an oval cross-sectional shape that deviates from the circular shape. This makes it possible, on the one hand, to seal the sealing spaces in a completely fluid-tight manner and, on the other hand, to use conventional and mass-produced single-conductor seals for this purpose. In the present case, the single-conductor seals are not shown.

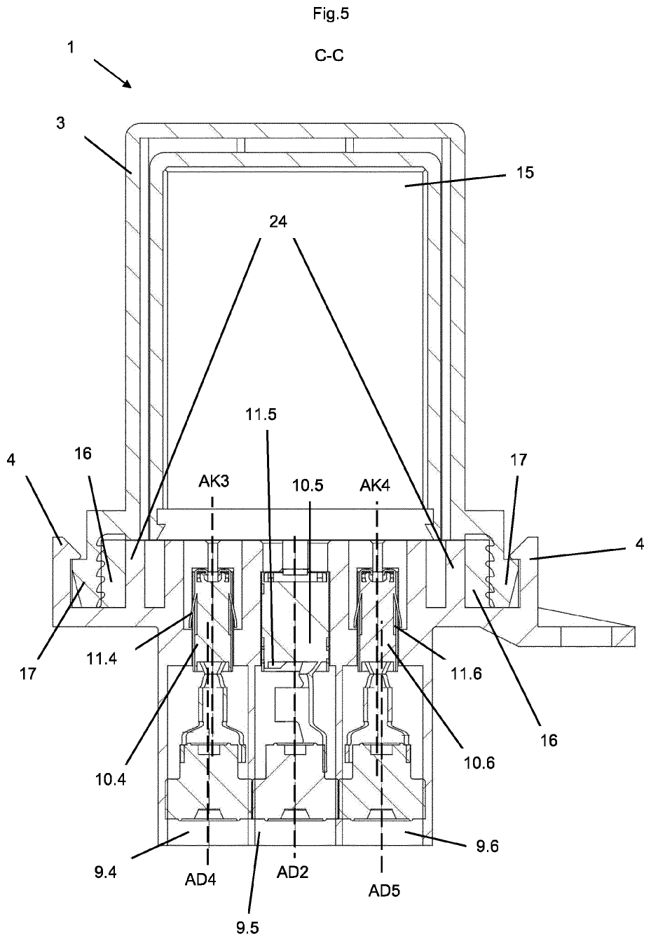

FIG. 5 shows a sectional view along the axis C-C marked in FIG. 2. The sealing spaces 9.4, 9.5 and 9.6 can be seen.

The sealing spaces 9.4, 9.5 and 9.6 are adjoined by the contact chambers 10. In the present case, the contact chamber 10.4 adjoins the sealing space 9.4, the contact chamber 10.5 adjoins the sealing space 9.5 and the contact chamber 10.6 adjoins the sealing space 9.6.

The contacts 11, specifically 11.4, 11.5 and 11.6, are arranged in the contact chamber 10.4, 10.5 and 10.6 to establish an electrically conductive connection with the respective relay connection 18.

In the present case, the contact chamber 10.4 and the contact 11.4 are arranged in a manner offset in relation to the central longitudinal axis AD4 of the sealing space 9.4. In particular, the central longitudinal axis AK3 of the contact chamber 10.4 is arranged in a manner offset in the radial direction in relation to the longitudinal axis AD4 of the sealing space 9.4. In the present case, the offset amounts to 0.4 mm. Furthermore, in the present case, the contact chamber 10.6 and the contact 11.6 are arranged in a manner offset relative to the central longitudinal axis AD5 of the sealing space 9.6. In particular, the central longitudinal axis AK4 of the contact chamber 10.6 is arranged in a manner offset in the radial direction in relation to the longitudinal axis AD5 of the sealing space 9.6. In the present case, the offset amounts to 0.4 mm.

In contrast, the sealing space 9.5, the contact chamber 10.5 and the contact 11.5 are arranged coaxially on the common central longitudinal axis AD2 when viewed from such direction. However, as described in FIG. 4, the sealing space 9.5 on the one hand and contact chamber 10.5 and contact 11.5 on the other hand are arranged in a manner offset one behind the other in the depth direction of the drawing plane.

It can also be seen in FIG. 5 that, in order to establish the contact pressure on the seal 16 on the base 2, latching hooks 4 are formed on opposite sides, which latching hooks engage around a circumferential edge 17 of the cover 3 from the outside and engage in a positive-locking manner behind it. This transmits a force to the seal 16 in both the axial and radial directions.

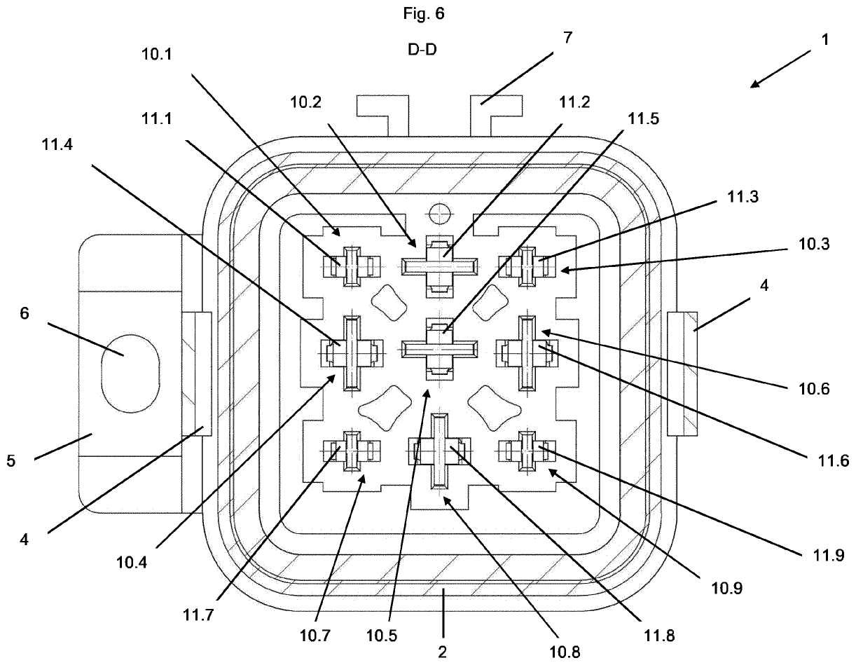

FIG. 6 is a sectional view along the axis D-D marked in FIG. 4. In this view, the contact chambers 10 along with the contacts 11 arranged therein in each case can be seen with a view from the volume space 15.

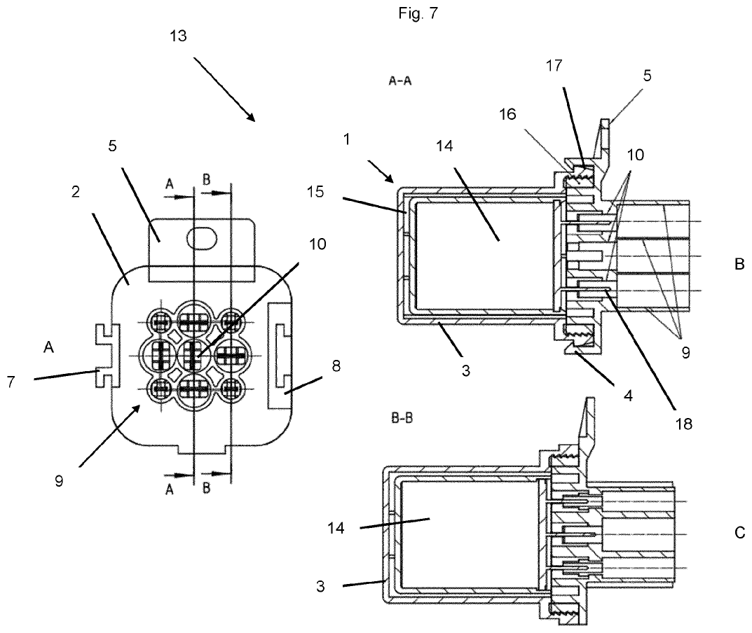

FIG. 7 shows various views of a system 13 having a housing 1 along with a motor vehicle relay 14. View 1 shows the system 13 from below, with a view to the lower side of the base 2. View B is a sectional view along the sectional axis A-A, while view C is a sectional view along the sectional axis B-B.

View A shows the base 2, the fastening lug 5, the connecting means 7, 8, the sealing spaces 9 arranged in a grid pattern along with the contact chambers 10.

Moreover, the sectional views show the relay 14 along with the contact chambers 10. The relay 14 is arranged in a volume space 15 provided by the cover 3, which in the present case is sealed in a fluid-tight manner by the base 2. For this purpose, a circumferential seal 16 is arranged in the radial and axial direction between the cover 3 and the base 2 with reference to the image plane of view B of FIG. 2 and, in the present closed state of the housing 1, is subjected to a contact pressure in precisely such directions. This ensures that the same fluid tightness, in particular water tightness, is achieved regardless of the spatial orientation of the housing 1. To establish the contact pressure, latching hooks 4 are formed on opposite sides of the base 2, which engage around a circumferential edge 17 of the cover 3 from the outside and engage in a positive-locking manner behind it. This transmits a force to the seal in both the axial and radial directions.

With reference to view B, it can be seen that the total of nine flat terminals 18 of the present 9-pole motor vehicle relay 14 are in each case inserted into a contact chamber 10 of the base 2 and are in contact with the contact 11 arranged there.

In terms of material technology, the cover and base are formed from fluid-tight plastic. The seal 16 is formed from rubber. In the present case, the contacts 11 are formed from an electrically conductive metal or alloy.

FIG. 8 shows an upper view (view B) and a lower view (view A) of a modular system 19 in accordance with the invention.

Two housings I can be seen, which housings are coupled to one another by means of correspondingly designed connecting means 7, 8. The housings 1 are connected to one another by means of the connecting means 7, 8 at edges arranged in a manner running parallel to one another of the respective base 2 via a positive-locking connection 20.

The connecting means 7, 8 are arranged on the corresponding edges of the respective base.

By coupling the housings to form the modular system, a number of relays 14 can be arranged in a watertight manner in damp or wet regions of a vehicle and previously inaccessible control functions can be realized in such regions.

### LIST OF REFERENCE SIGNS

1 Housing
2 Base
3 Cover
4 Latching hooks
5 Fastening lug
6 Recess
7 Connecting means
8 Connecting means
9 Sealing space
10 Contact chamber
11 Contact
12 Outer wall
13 System
14 Relay
15 Volume space
16 Circumferential seal
17 Circumferential edge
18 Flat terminal
19 Modular system
20 Positive-locking connection
21 Pocket
22 Latching tab
23 Sealing element
24 Contact surface
AD1 Longitudinal axis of sealing space
AD2 Longitudinal axis of sealing space
AD3 Longitudinal axis of sealing space
AD4 Longitudinal axis of sealing space
AD5 Longitudinal axis of sealing space
AK1 Longitudinal axis of contact chamber
AK2 Longitudinal axis of contact chamber
AK3 Longitudinal axis of contact chamber
AK4 Longitudinal axis of contact chamber

1.-15. (canceled)

16. A housing for a motor vehicle relay having a number of at least six flat terminals, comprising:
a cover that provides a volume space, open on one side, for receiving the motor vehicle relay; and
a base that closes the volume space in a fluid-tight manner in a closed state,
wherein the base, corresponding to the number of flat terminals of the motor vehicle relay, has at least six electrical contacts for electrically connecting the motor vehicle relay,
wherein each electrical contact is arranged in a separate contact chamber that is open towards the volume space,
wherein each contact chamber is adjoined by a respective sealing space that is accessible from outside the housing, and
wherein a sealing element having a central channel for guiding an electric wire is arranged in each sealing space.

17. The housing according to claim 16,
wherein at least one of the sealing spaces has an elliptical internal cross-sectional shape.

18. The housing according to claim 16,
wherein at least one of the contact chambers is arranged at an offset relative to a central longitudinal axis of the adjoining sealing space.

19. The housing according to claim 18,
wherein the contact arranged in the at least one of the contact chambers is also arranged at an offset in relation to the central longitudinal axis of the adjoining sealing space.

20. The housing according to claim 18,
wherein the offset amounts to between 0.2 mm and 0.7 mm.

21. The housing according to claim 16,
wherein the sealing element is a hollow cylindrical single-conductor seal.

22. The housing according to claim 16,
wherein the cover and/or the base are made of plastic.

23. The housing according to claim 16,
wherein the contact chamber has a rectangular internal cross-sectional shape.

24. The housing according to claim 16,
further comprising a circumferential seal,
wherein, in the closed state, the circumferential seal is arranged between the cover and the base and subjected to contact pressure in both an axial direction and a radial direction.

25. The housing according to claim 24,
wherein the circumferential seal is arranged completely between the base and the cover both in a vertical direction and orthogonally to the vertical direction.

26. The housing according to claim 16,
wherein the cover and the base can be connected in a positive-locking and/or force-fitting manner.

27. The housing according to claim 26,
wherein the cover and base have corresponding connecting elements, in particular latching means, to form the connection.

28. The housing according to claim 16,
further comprising a fastening means arranged on the base for directly fastening the base to a vehicle.

29. A modular system having at least two housings according to claim 16,
wherein the at least two housings can be coupled to one another via corresponding connecting means along edges running in parallel.

30. A system, comprising
the housing according to claim 16, and
an at least 6-pole motor vehicle relay with at least six flat terminals,
wherein the motor vehicle relay is arranged in the volume space of the cover that is sealed in a fluid-tight manner,
wherein the flat terminals of the motor vehicle relay are inserted into the respective corresponding contact chamber and are in contact with the respective corresponding electrical contact of the base.
